(19) United States
(12) Patent Application Publication
(10) Pub. No.: US 2010/0095096 A1
(43) Pub. Date: Apr. 15, 2010

(54) AV DEVICE AND ITS CONTROL METHOD

(76) Inventor: Shirou Yoshioka, Hyogo (JP)

Correspondence Address: MCDERMOTT WILL & EMERY LLP, 600 13TH STREET, NW, WASHINGTON, DC, 20005-3096, US

(21) Appl. No.: 12/526,221

(22) PCT Filed: Jun. 27, 2008
(86) PCT No.: PCT/JP2008/001683

§ 371 Date: Aug. 6, 2009

(30) Foreign Application Priority Data
Jun. 28, 2007 (JP) 2007-170170

(51) Int. Cl. G06F 9/30

(52) U.S. Cl. 712/220; 712/E09.016

(57) ABSTRACT

In an AV device control, from unit instructions (210, 220, 230) for executing a series of operations, input parts (211, 221, 231) for allowing user inputs to be inputted are respectively extracted and the extracted input parts (211, 221, 231) are concatenated as a first process, and execution parts (212, 222, 232) for operating the AV device according to the inputted user inputs are respectively extracted and the extracted execution parts (212, 222, 232) are concatenated as a second process. Then, the first process is arranged to be followed by the second process to constitute a macro instruction (240). In control using the macro instruction (240), after the user inputs required for executing the macro instruction are all inputted by the first process, the macro instruction by the second process is executed.

### TECHNICAL FIELD

The present invention relates to AV devices, and specifically to AV devices capable of executing a plurality of unit instructions as a series of processes.

### BACKGROUND ART

For writing recorded data of an analog terrestrial broadcast to a DVD-RW in a DVD recorder which is one of AV devices, it is necessary to sequentially perform the following processes: (1) formatting a DVD, (2) selecting and writing moving-picture data, and (3) finalizing the DVD. It takes several minutes to perform the process (1), several tens of minutes to perform the process (2), and several minutes to perform the process (3). Moreover, a menu of each process is hierarchized, so that the operation of going down the hierarchy is necessary. As described above, writing recorded data to a DVD is very burdensome work for users.

FIG. 14 shows a schematic configuration of a conventional execution device in an AV device. For performing (1) formatting a DVD, a user first gives the instruction of performing formatting the DVD through user input means 1200. Selection means 1201 selects an instruction processing device 1202 to allow the user to input through input means 1210 whether or not the user surely wants to execute the formatting. If the user wants to execute the formatting, execution means 1211 executes formatting. For performing (2) selecting and writing moving-picture data, the user first gives the instruction of performing selecting and writing moving-picture data through the user input means 1200. The selection means 1201 selects an instruction processing device 1203 to allow the user to input selected moving-picture data through input means 1220, and execution means 1221 writes the moving-picture data to a DVD-RW. For performing (3) finalizing the DVD, the user first gives the instruction of performing finalizing the DVD through the user input means 1200. The selection means 1201 selects an instruction processing device 1204 to allow the user to input through input means 1230 whether or not the user wants to execute the finalizing DVD. If the user wants to execute the finalizing, execution means 1231 finalizes the DVD-RW.

For the above-mentioned present situation, the technology of automatically registering a series of operations executed at a high frequency is known (Patent Documents 1 and 2). This technology may make it possible to sequentially execute the above-mentioned processes (1), (2), and (3), without going down the hierarchy of the hierarchized menu.
[Patent Document 1] Japanese Unexamined Patent Publication H10-240412
[Patent Document 2] Japanese Unexamined Patent Publication H05-35382

### DISCLOSURE OF INVENTION

Problems to be Solved by the Invention

However, even if the above-mentioned technology is introduced, the process (1) has to be completed to enable the process (2) to be started, and the process (2) has to be completed to enable the process (3) to be started. This results in that the user is tied down to the DVD recorder for about 20 minutes to sequentially perform operations in accordance with (1), (2), and (3). The user may do some other work, but the work is interrupted every time the processes (1), (2), and (3) are each completed. Moreover, every time the processes (1), (2), and (3) are each completed, watching a TV program is interrupted.

In view of the above problems, an object of the present invention is to enable a series of operations in controlling an AV device to be realized, without tying down a user to the AV device.

Means for Solving the Problems

In the present invention, a set of a plurality of unit instructions executed as a series of processes is registered as a macro instruction. For this purpose, from unit instructions for constituting a macro instruction, input parts for allowing user inputs to be inputted are respectively extracted and the extracted input parts are concatenated as a first process, and execution parts for operating an AV device according to the inputted user inputs are respectively extracted and the extracted execution parts are concatenated as a second process. Then, the first process is arranged to be followed by the second process to constitute the macro instruction. In control using the macro instruction, after user inputs required for executing the macro instruction are all inputted by the first process, the macro instruction by the second process is executed.

Effects of the Invention

According to the present invention, after a user collectively performed user inputs required for, for example, the processes (1), (2), and (3) mentioned above, the processes (1), (2), and (3) are executed in the manner of push-away processing based on the user inputs. Therefore, the user does not have to wait completion of each of the processes (1), (2), and (3), which enables the user to use another function of, for example, reproducing recorded data in the AV device.

### BRIEF DESCRIPTION OF DRAWINGS

FIG. 1 is a view showing a schematic configuration of an AV device according to an embodiment of the present invention.

FIG. 2 is a view showing a configuration of a registration device according to the embodiment of the present invention.

FIG. 3 is a view showing an example configuration of a macro instruction.

FIG. 4 shows a macro instruction generating algorithm of the embodiment of the present invention.

FIG. 5 is a view showing a configuration of an execution device according to the embodiment of the present invention.

FIG. 6 is a view showing a configuration of a registration device according to another embodiment of the present invention.

FIG. 7 is a view showing an example configuration of a macro instruction.

FIG. 8 shows a macro instruction generating algorithm of said another embodiment of the present invention.

FIG. 9 shows an example in which execution of the macro instruction is displayed on a sub-screen.

FIG. 10 is a view showing an example configuration of a macro instruction.

FIG. 11 shows a macro instruction generating algorithm of still another embodiment of the present invention.

FIG. 12 shows an example in which execution of the macro instruction is displayed on a sub-screen.

FIG. 13 shows a configuration of an AV device specifically realizing the present invention.

FIG. 14 shows a schematic configuration of a conventional execution device in an AV device.

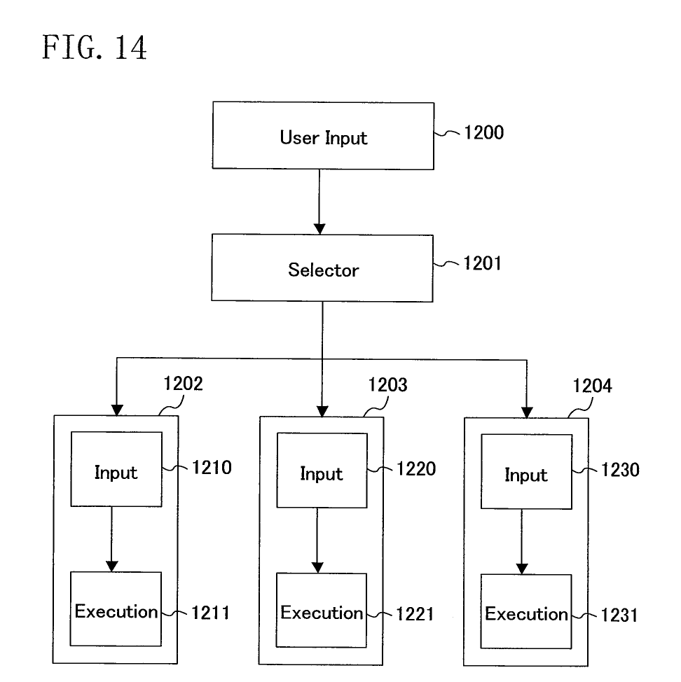

### DESCRIPTION OF CHARACTERS

1 Instruction List
2 Execution Frequency Detecting Section
3 Macro Instruction Generation Command Issuing Section
4 Input Part and Execution Part Extracting Section
5 Macro Instruction Generating Section
6 Macro Instruction Registering Section
7 Macro Instruction Specifying Section
10 AV Device
11 Hard Disk
12 Writing Section
13 Optical Disk
14 Formatting Section
15 Finalizing Section
16 Control Section
17 User Interface Section
18 Display
210, 220, 230 Unit Instruction
211, 221, 231 Input Part
212, 222, 232 Execution Part
240, 500, 900 Macro Instruction
701 Sub-screen
801 Macro Instruction User Input Section
802 Macro Instruction Execution Section
1300 AV Device
1301 Registration Device
1302 Execution Device

### BEST MODE FOR CARRYING OUT THE INVENTION

Hereinafter, embodiments of the present invention will be described with reference to the drawings.

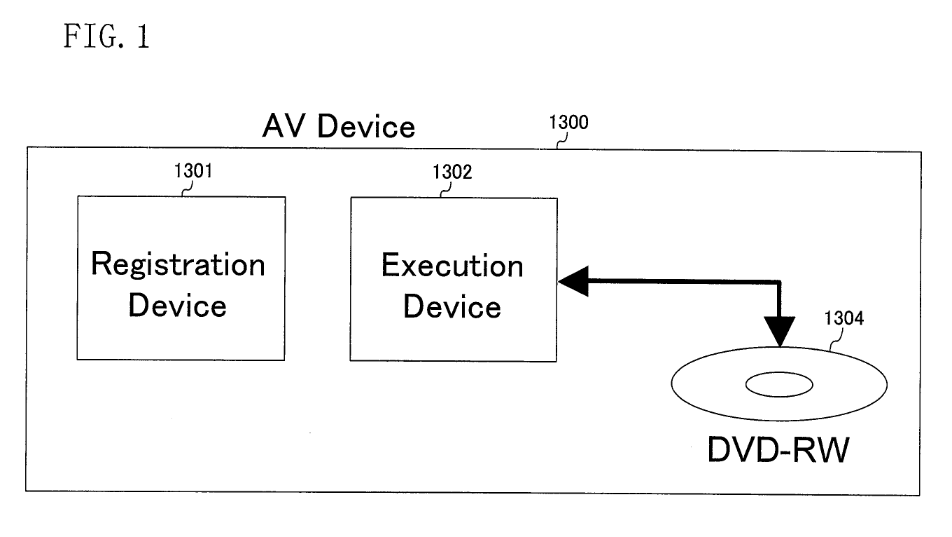

FIG. 1 is a view showing a schematic configuration of an AV device according to an embodiment of the present invention. An AV device 1300 of FIG. 1 includes a registration device 1301 for registering a macro instruction, an execution device 1302 for executing an instruction inclusive of the macro instruction, and a DVD-RW reading and writing device 1304.

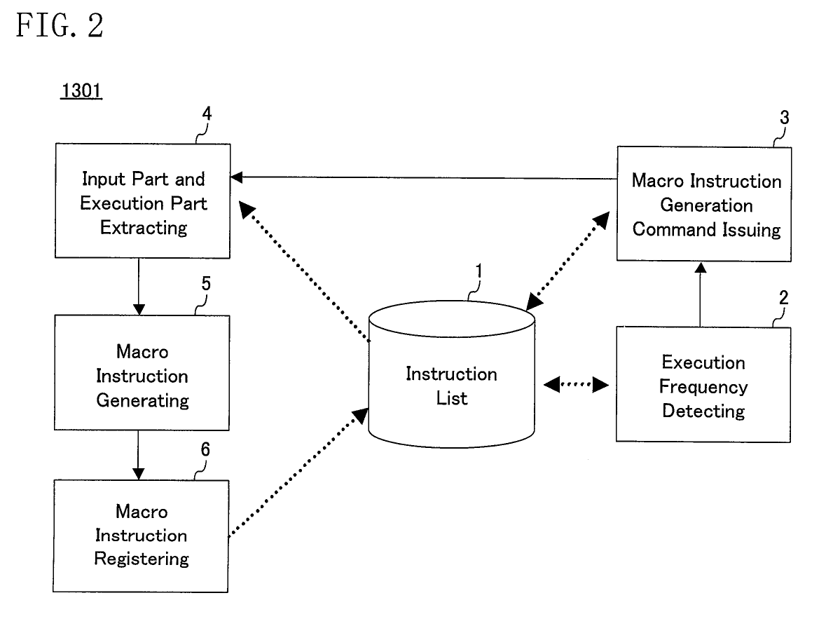

FIG. 2 is a view showing a configuration of the registration device 1301 according to the present embodiment. In FIG. 2, an instruction list 1 is a list of instructions which the AV device has, and an execution frequency detecting section 2 detects the execution frequency of each instruction in the instruction list 1 and writes the frequency to the instruction list 1. The execution frequency detecting section 2 also detects a series of operations executed at an especially high frequency. Methods for detecting a series of operations executed at a high frequency are disclosed in Patent Documents 1 and 2, and thus descriptions thereof are not given here in detail. When the execution frequency detecting section 2 detects a series of operations executed at a high frequency, the execution frequency detecting section 2 informs a macro instruction generation command issuing section 3 of a sequence of the series of instructions. The macro instruction generation command issuing section 3 issues a command, with the sequence of the series of instructions, for conversion thereof into a macro instruction to an input part and execution part extracting section 4. The input part and execution part extracting section 4 extracts input parts and execution parts of the respective instructions from the instruction list 1, gives the input parts and the execution parts of the respective instructions to a macro instruction generating section 5, and instructs the macro instruction generating section 5 to generate the macro instruction therefrom. The macro instruction generating section 5 generates the macro instruction, and instructs a macro instruction registering section 6 to register the macro instruction into the instruction list 1.

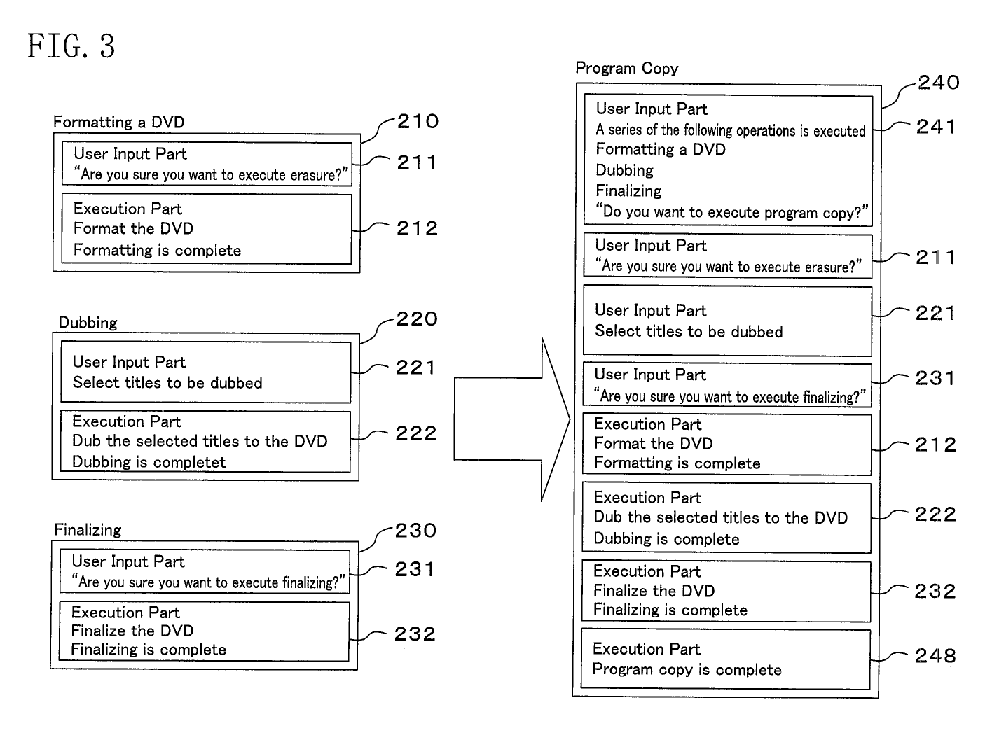

With reference to FIG. 3, the above operation will be described further in detail. Here, a macro instruction used for writing recorded data of an analog terrestrial broadcast to a DVD-RW in a DVD recorder serving as the AV device is taken as an example. For this purpose, it is necessary to sequentially perform the following processes: (1) formatting a DVD, (2) selecting and writing moving-picture data, and (3) finalizing the DVD.

An instruction (i.e., a unit instruction) 210 for formatting a DVD has an input part 211 and an execution part 212. The input part 211 causes an operation screen to display “Are you sure you want to execute erasure?” to actually execute the erasure only when a user answers “Yes,” thereby preventing accidental erasure. Moreover, on completion of formatting, the execution part 212 causes the operation screen to display “Formatting is complete” to inform the user that a next instruction can be executed.

An instruction (i.e., a unit instruction) 220 for selecting and writing (i.e., for dubbing) moving picture data has an input part 221 and an execution part 222. The input part 221 allows selecting a title to be dubbed. On completion of dubbing, the execution part 222 causes the operation screen to display “Dubbing is complete” to inform the user that a next instruction can be executed.

An instruction (i.e., a unit instruction) 230 for finalizing the DVD has an input part 231 and an execution part 232. The input part 231 causes the operation screen to display “Are you sure you want to execute finalizing?” to actually execute the finalizing only when the user answers “Yes,” thereby preventing erroneous operation.

It is provided that the case where the instruction 210 (i.e., formatting DVD), the instruction 220 (i.e., selecting and writing moving-picture data), and the instruction 230 (i.e., finalizing DVD) described above are sequentially performed occurs frequently, and that the execution frequency detecting section 2 detects this case and instructs the macro instruction generation command issuing section 3 to convert the instructions 210, 220, and 230 to a macro instruction. Then, the macro instruction generation command issuing section 3 issues a command, with the instructions 210, 220, and 230, for conversion thereof into the macro instruction to the input part and execution part extracting section 4. From the instruction list 1, the input part and execution part extracting section 4 extracts the input part 211, the execution part 212, the input part 221, the execution part 222, the input part 231, and the execution part 232. The input part and execution part extracting section 4 gives the input parts 211, 221, and 231 and the execution parts 212, 222, and 232 to the macro instruction generating section 5 and instructs the macro instruction generating section 5 to generate the macro instruction. The macro instruction generating section 5 generates a macro instruction 240 and instructs the macro instruction registering section 6 to register the macro instruction 240 into the instruction list 1.

It should be noted that the unit instructions 210, 220, and 230 can be executed individually.

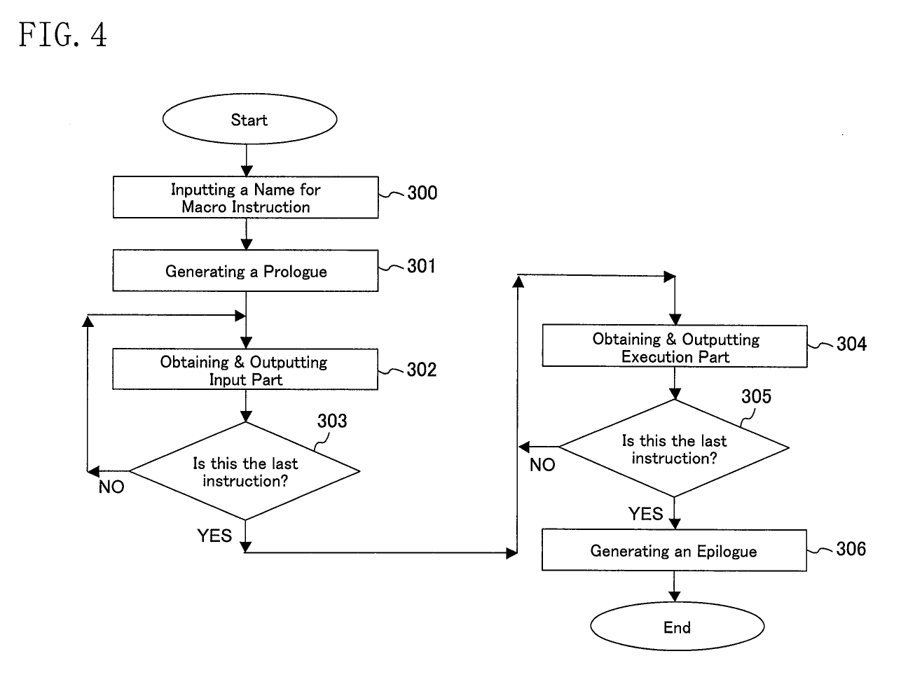

Moreover, the process of generating the macro instruction 240 by the macro instruction generating section 5 will be described with reference to FIG. 4.

At the step 300 of inputting a name for a macro instruction, “Please input a name for a macro instruction” is displayed to a user, and the user inputs a name for a macro instruction. In this example, it is provided that the user inputs “Program copy” as a name for the macro instruction. Next, a prologue generation step 301 is executed to generate a prologue 241. The prologue 241 starts with “A series of the following operations is performed” followed by names of the instructions, that is, “formatting a DVD,” “Dubbing,” and “Finalizing,” and finally ends with a message asking “Do you want to execute program copy?” using the name of the macro instruction inputted at the step 300, that is, “Program copy.”

Next, at steps 302 and 303, the input parts 211, 221, and 231 are extracted, and at steps 304 and 305, the execution parts 212, 222, and 232 are extracted. The extracted input parts 211, 221, and 231 are concatenated as a first process, and the extracted execution parts 212, 222, and 232 are concatenated as a second process. The first process is arranged to be followed by the second process, thereby the macro instruction is generated.

First, at the step 302, the input part 211 is obtained and outputted. The input part 211 is not the last instruction at the step 303, and thus the input part 221 is obtained and outputted at the step 302. The input part 221 is not the last instruction at the step 303, and thus the input part 231 is obtained and outputted at the step 302. The input part 231 is the last instruction at the step 303, and thus the execution part 212 is obtained and outputted at the step 304. The execution part 212 is not the last instruction at the step 305, and thus the execution part 222 is obtained and outputted at the step 304. The execution part 222 is not the last instruction at the step 305, and thus the execution part 232 is obtained and outputted at the step 305. The execution part 232 is the last instruction at the step 305, and thus an epilogue 248 is generated at the step 306. Here, the epilogue 248 is “Program copy is complete” using the name of the macro instruction input at the step 300, that is, “Program copy.”

It should be noted that as to at least one of the plurality of unit instructions constituting the macro instruction, a result of the input part can be fixed based on an instruction from the user.

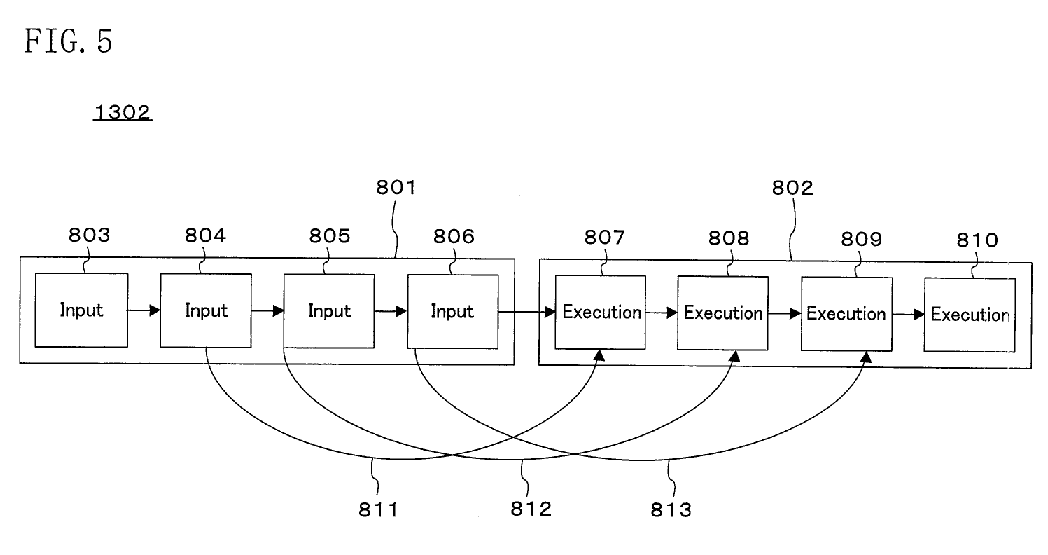

FIG. 5 is a view showing a configuration of the execution device 1302 according to the present embodiment for executing the macro instruction registered as described above. The execution device 1302 of FIG. 5 includes a macro instruction user input section 801 having input means 803 to 806; a macro instruction execution section 802 having execution means 807 to 810; and input information transmission means 811 to 813 for transmitting information input to the macro instruction user input section 801 to the macro instruction execution section 802.

To execute the macro instruction 240, the input means 803 executes the prologue 241 to ask the user “Do you want to execute program copy?.” If the user answers “Yes,” control proceeds to the input means 804. The input means 804 executes the input part 211 to allow a user input as to whether or not to perform formatting. The input means 805 executes the input part 221 to allow selecting titles to be dubbed. The input means 806 executes the input part 231 to allow a user input as to whether or not to perform finalizing. Moreover, from the input information transmission means 811, the execution means 807 receives the information as to whether or not to perform the formatting, and if the formatting is to be performed, the execution means 807 executes the formatting. From the input information transmission means 812, the execution means 808 receives the information of the titles to be dubbed, and executes the dubbing in order of the titles to be dubbed. From the input information transmission means 813, the execution means 809 receives the information as to whether or not to perform the finalizing, and if the finalizing is to be performed, the execution means 809 executes the finalizing. Finally, the execution means 810 executes the epilogue 248 to display “Program copy is complete.”

That is, according to the present embodiment, a macro instruction is used to control an AV device, wherein after user inputs required for executing the macro instruction are all inputted, the macro instruction is executed.

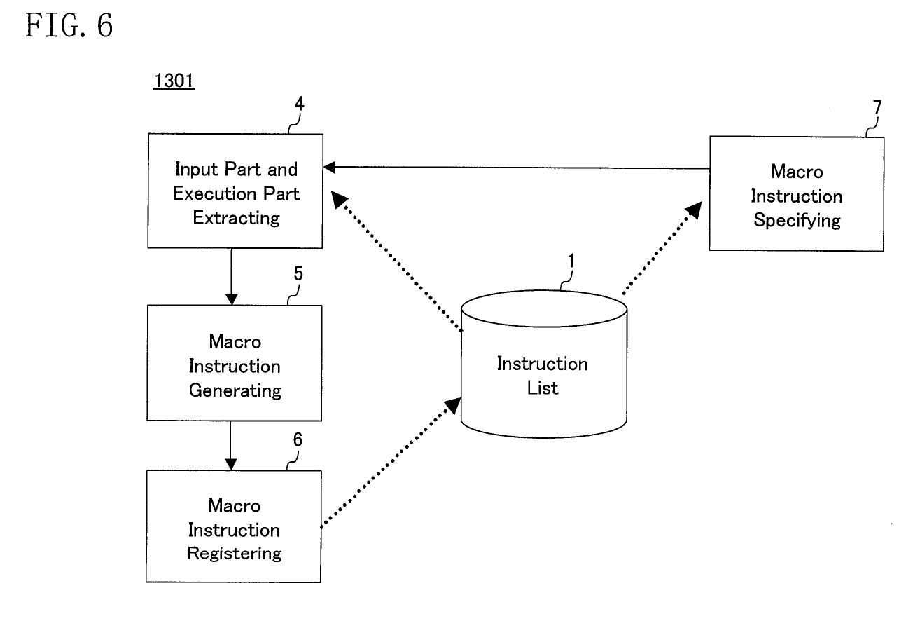

The foregoing shows an example with the maximized automation, but it is also possible to allow a human user to strategically perform a detailed setting. FIGS. 6 to 8 show an example of such a case.

FIG. 6 is a view showing a configuration of a registration device 1301 according to another embodiment of the present invention. In FIG. 6, components 1, 4, 5, and 6 are substantially the same as those of FIG. 2. A macro instruction specifying section 7 can be activated by a user from a menu of an AV device. Activating the macro instruction specifying section 7 enables the user to specify a series of instructions which is to be converted into a macro instruction.

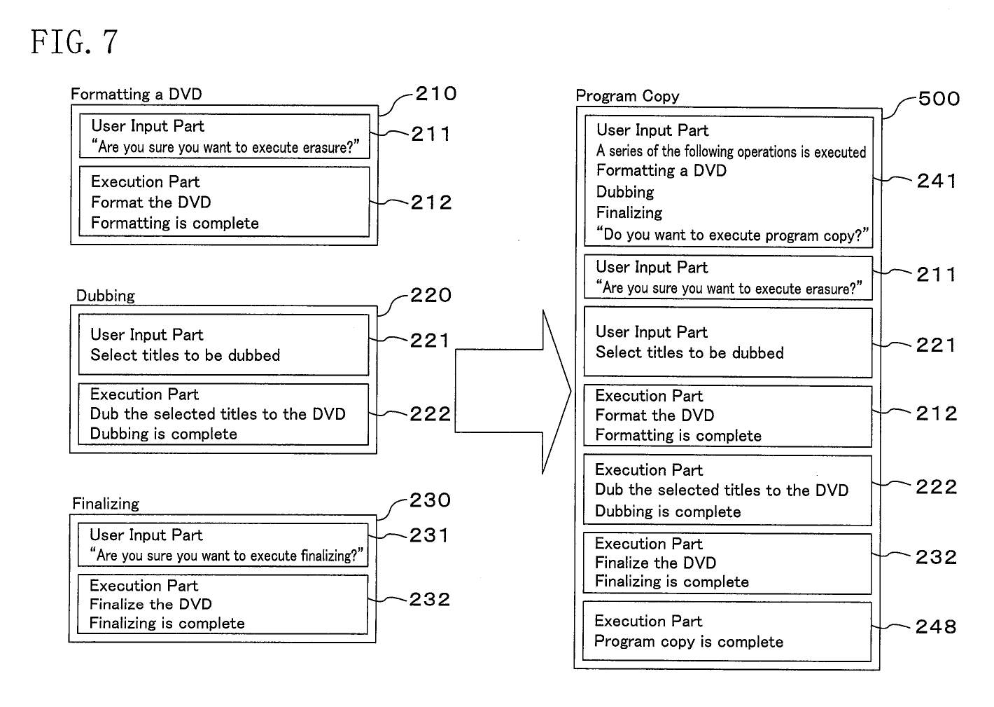

With reference to FIG. 7, the above operation will be described further in detail. As in FIG. 3, a macro instruction used for writing recorded data of an analog terrestrial broadcast to a DVD-RW in a DVD recorder serving as the AV device is taken as an example. For this purpose, it is necessary to sequentially perform the following processes: (1) formatting a DVD, (2) selecting and writing moving-picture data, and (3) finalizing the DVD. FIG. 7 is different from FIG. 3 in that a macro instruction 500 does not include the input part 231 of the instruction 230.

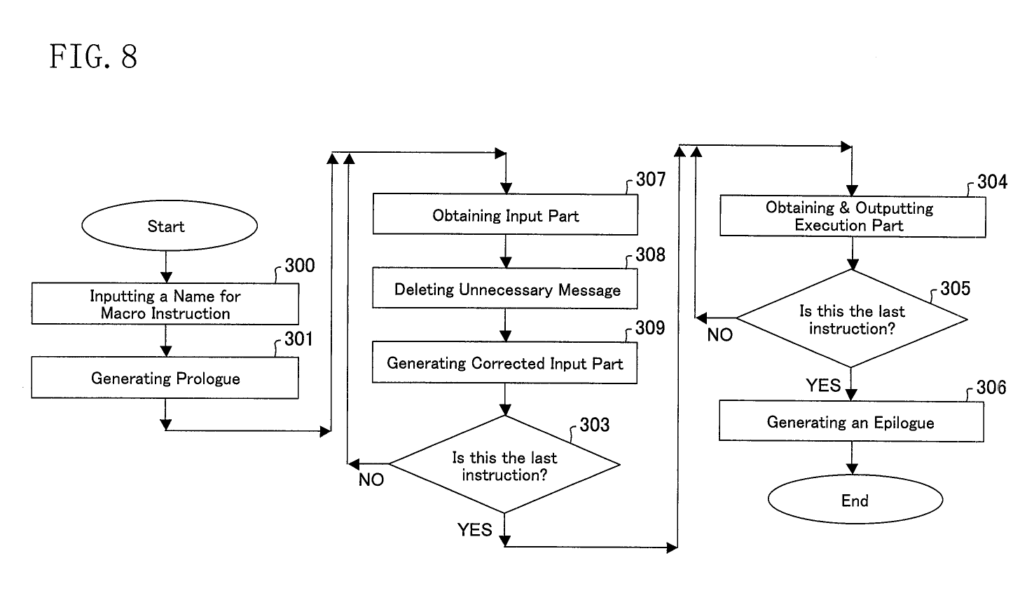

Moreover, the process of generating the macro instruction 500 by the macro instruction generating section 5 will be described with reference to FIG. 8. FIG. 8 is different from FIG. 4 in that at steps 307, 308, and 309, an unnecessary message can be deleted. Steps 300, 301, and 303 to 306 are substantially the same as those of FIG. 4.

After a prologue 241 is generated at the step 301, an input part 211 is obtained at the step 307. At the step 308, the user is asked whether or not to delete a message, and the user specifies not to delete a message by the input part 211. Thus, at the step 309, the input part 211 is outputted without being deleted. The input part 211 is not the last instruction at the step 303, and thus an input part 221 is obtained at the step 307. At the step 308, the user is asked whether or not to delete a message, and the user specifies not to delete a message by the input part 221. Thus, at the step 309, the input part 221 is outputted without being deleted. The input part 221 is not the last instruction at the step 303, and thus an input part 231 is obtained at the step 307. At the step 308, the user is asked whether or not to delete a message, and the user specifies to delete a message by the input part 231. Thus, at the step 309, nothing is outputted. The input part 231 is the last instruction at the step 303, and thus an execution part 212 is obtained and outputted at the step 304. Substantially the same process as that of FIG. 4 follows.

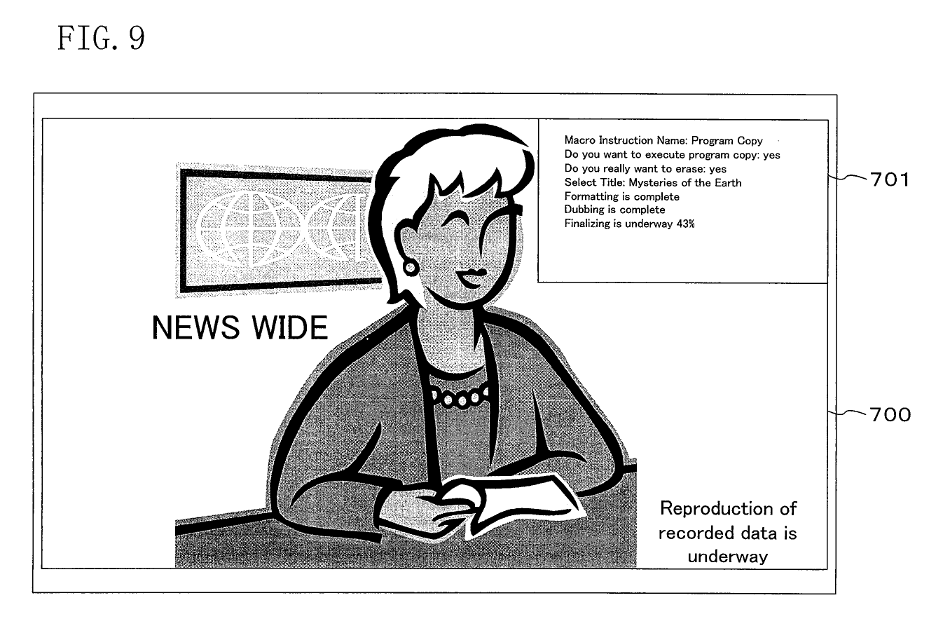

FIG. 9 shows a situation in which for writing recorded data of an analog terrestrial broadcast to a DVD-RW in a DVD recorder, the present invention is used to perform the following processes: (1) formatting a DVD, (2) selecting and writing moving-picture data, and (3) finalizing the DVD, in the manner of push-away processing whose progress is displayed on a sub-screen 701, during which another recorded data in the AV device is reproduced on a main screen 700. That is, in the present embodiment, during execution of a second process obtained by concatenating execution parts, the AV device can execute a process different from a process by the macro instruction. In doing that, information showing which one of the unit instructions constituting the macro instruction is currently executed is displayed on the sub-screen 701. During writing recorded data of an analog terrestrial broadcast to a DVD-RW in a DVD recorder, a user is still allowed to watch another recorded data and to check completion of the writing to the DVD on the sub-screen 701, thereby usability is improved.

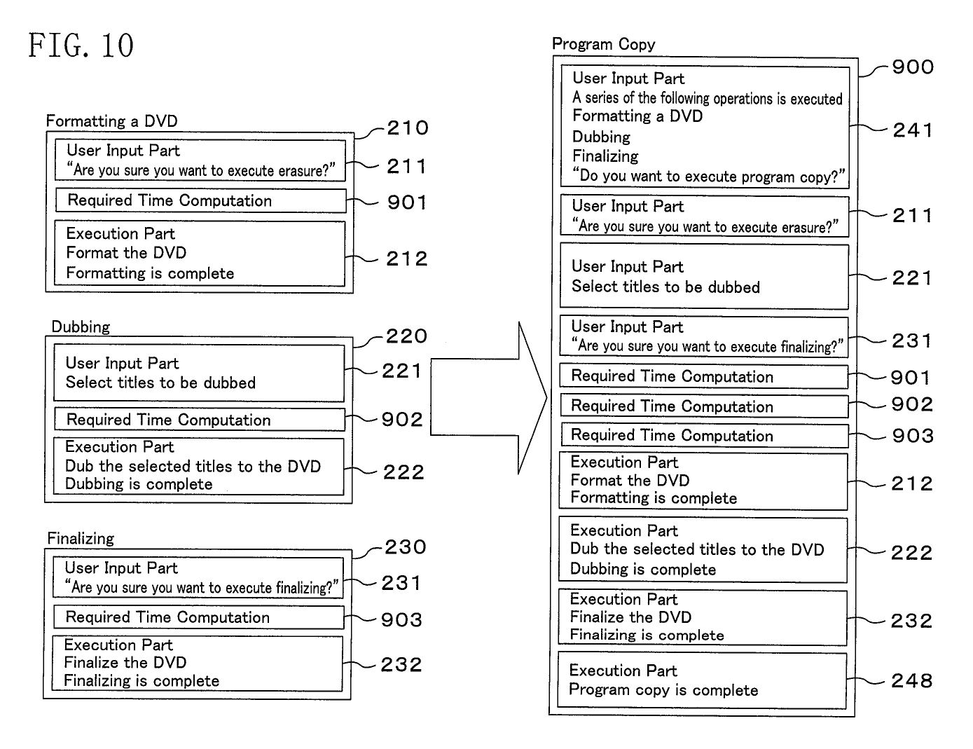

FIG. 10 is an example in which computations of required time for executing instructions are added to the instructions and the macro instruction of FIG. 3. It can be seen that required time computations 901, 902, and 903 are added to the instructions 210, 220, and 230 and a macro instruction 900.

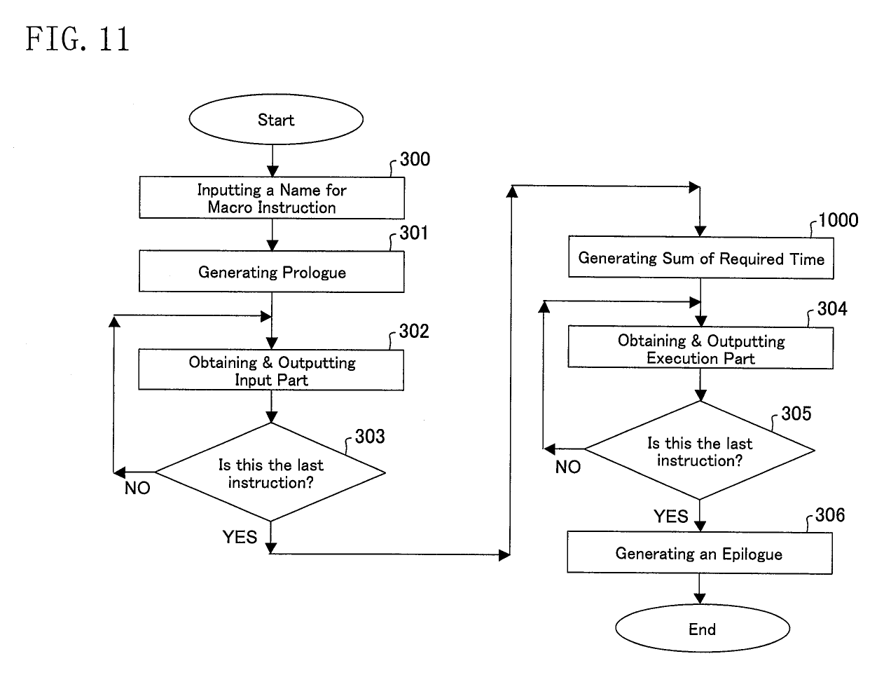

A process flow of the macro instruction generating section 5 in this case will be described with reference to FIG. 11. FIG. 11 is different from FIG. 4 in that the step 1000 of generating a sum of required time is added. Here, the required time computations 901, 902, and 903 are generated to be included in the macro instruction 900, and thus when the macro instruction 900 is executed, the sum is computed and displayed on the screen.

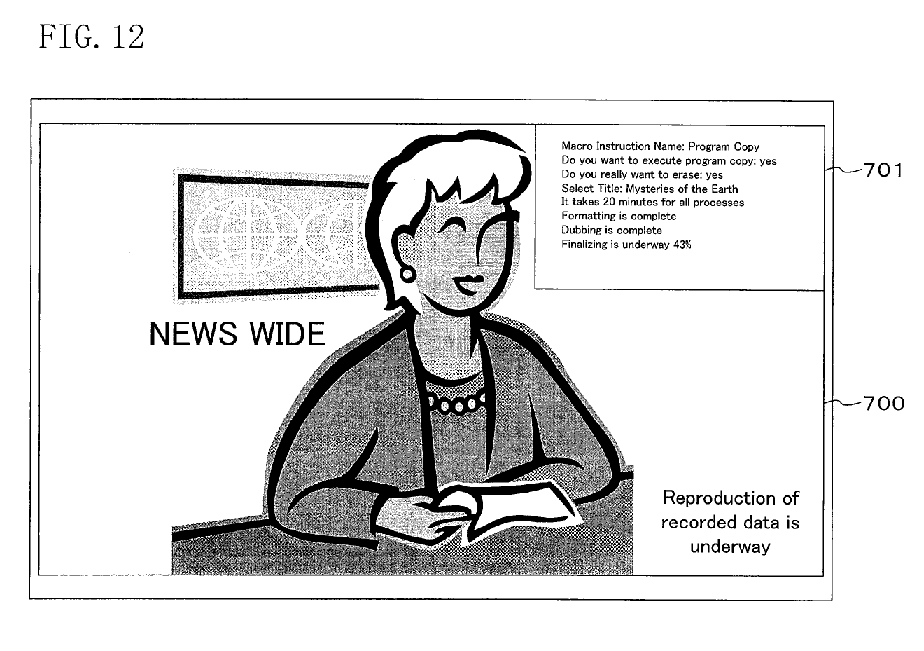

FIG. 12 shows a display of the above-mentioned situation. After “Mysteries of the earth” is selected in selecting titles, whether or not to perform finalizing is not asked in FIG. 12, but “It takes 20 minutes for all processes” is displayed. With such a display, the user can know how much time the processes take, so that the user does not have to have feeling of impatience even if the sub-screen 701 is displayed.

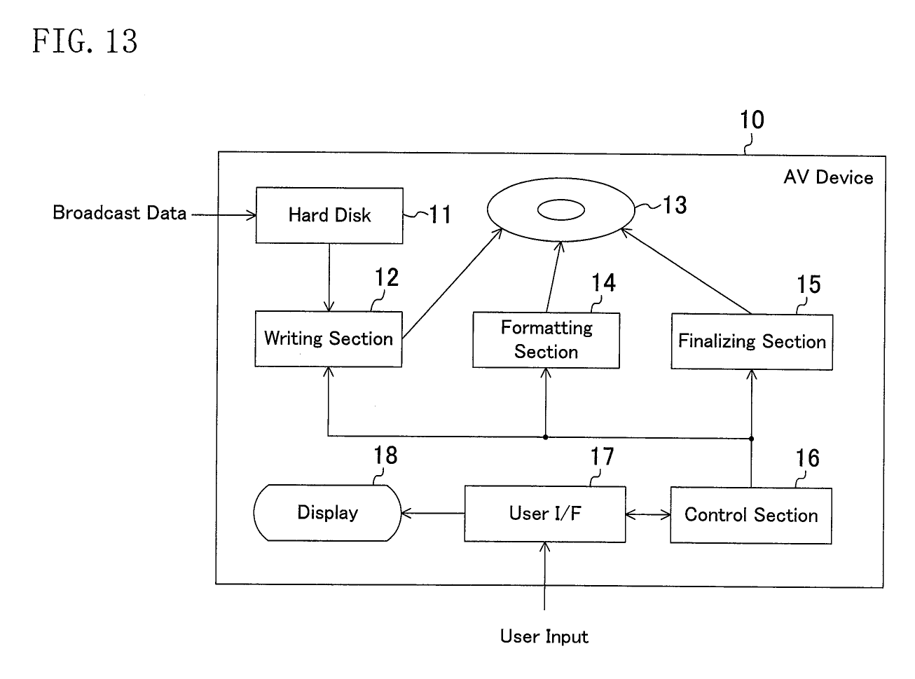

FIG. 13 is a view showing a configuration of an AV device specifically realizing the present invention. An AV device 10 of FIG. 13 can once store provided broadcast data in a hard disk 11, and can write the stored broadcast data to an optical disk 13. A formatting section 14 formats the optical disk 13. A writing section 12 selects, from the broadcast data stored in the hard disk 11, broadcast data to be written to the optical disk 13, and writes the selected broadcast data to the optical disk 13. A finalizing section 15 processes the optical disk 13 having the broadcast data written thereto to enable the optical disk 13 to be replayed in other AV devices. A user interface section 17 displays a character or an icon on a display 18 to give information to a user, and receives user inputs including a command. A control section 16 controls the formatting section 14, the writing section 12, and the finalizing section 15 based on the user inputs inputted to the user interface section 17.

When a command for writing the broadcast data to the optical disk 13 is inputted to the user interface section 17, the user interface section 17 gives information to the user to input all information respectively required for operating the formatting section 14, the writing section 12, and the finalizing section 15, with none of the formatting section 14, the writing section 12, and the finalizing section 15 being put into operation. Then, after the information required for operating the respective sections is all inputted to the user interface section 17, the formatting section 14, the writing section 12, and the finalizing section 15 are successively put into operation in this order based on the inputted user input.

It should be noted that in the above-mentioned embodiment, the case of forming a macro instruction constituted by the unit instructions, i.e., formatting a DVD, selecting and writing moving-picture data, and finalizing the DVD is described as an example, but the present invention is not limited to this example, and the present invention is applicable to any macro instruction which is a set of a plurality of unit instructions executed as a series of processes.

### INDUSTRIAL APPLICABILITY

An AV device according to the present invention has the function of generating a macro instruction by rearranging input parts and execution parts, and is useful to ease the use of a series of instructions used at a high frequency.

1-15. (canceled)

16. A control method of an AV device, wherein
a macro instruction which is a set of a plurality of unit instructions executed as a series of processes is used to control the AV device,
after user inputs required for executing the macro instruction are all inputted, the macro instruction is executed, and
at least one of the plurality of unit instructions requires a user input for executing the at least one unit instruction, and includes an input part for allowing the user input to be inputted, and an execution part for operating the AV device according to the inputted user input,
the control method comprising a registration process of registering the macro instruction, the registration process including the steps of:
selecting, as instructions for constituting a macro instruction, a plurality of unit instructions executed as a series of processes from unit instructions which the AV device has;
extracting all the input parts from the selected plurality of unit instructions and concatenating the extracted input parts as a first process;
extracting all the execution parts from the selected plurality of unit instructions and concatenating the extracted execution parts as a second process; and
arranging the first process to be followed by the second process to constitute the macro instruction, wherein
in executing the registered macro instruction, the second process is executed after completion of the first process.

17. The control method of claim 16, wherein the plurality of unit instructions constituting the macro instruction can be executed individually.

18. The control method of claim 16, wherein
during execution of the second process, the AV device can execute a process different from a process by the macro instruction, and
while the process different from the process by the macro instruction is executed during the execution of the second process, information showing which one of the unit instructions constituting the macro instruction is currently executed is displayed on a sub-screen.

19. The control method of claim 16, wherein as to at least one of the plurality of unit instructions constituting the macro instruction, a result of the input part can be fixed based on an instruction from a user.

20. An AV device having a function of registering, as a macro instruction, a set of a plurality of unit instructions executed as a series of processes, the AV device comprising:
a macro instruction user input section to which, as to the plurality of unit instructions registered as the macro instruction, user inputs required for executing the respective unit instructions are sequentially inputted; and
a macro instruction execution section for executing the macro instruction based on the user inputs inputted to the macro instruction user input section, wherein
after the user inputs are all inputted to the macro instruction user input section, the macro instruction by the macro instruction execution section is executed
an execution sequence of the plurality of unit instructions registered as the macro instruction can be specified based on a user instruction, and
as to at least one of the plurality of unit instructions constituting the macro instruction, the user input to the macro instruction user input section can be omitted.

21. The AV device of claim 20, wherein
during execution of the macro instruction, the AV device can execute a process different from a process by the macro instruction, and
while the process different from the process by the macro instruction is executed during the execution of the macro instruction, information showing which one of the unit instructions constituting the macro instruction is currently executed is displayed on a sub-screen.

22. The AV device of claim 20, further comprising
a function of computing remaining time required for executing the macro instruction by summing remaining time required for executing the plurality of unit instructions constituting the macro instruction, wherein
after the user inputs are all inputted to the macro instruction user input section, the remaining time required for executing the macro instruction is computed.

23. An AV device comprising:
a macro instruction generation command issuing section for issuing a macro instruction generation command to generate a macro instruction by using a plurality of unit instructions executed as a series of processes;
an input part and execution part extracting section for receiving the macro instruction generation command, and for extracting all input parts and all execution parts from the plurality of unit instructions;
a macro instruction generating section for concatenating the input parts extracted by the input part and execution part extracting section as a first process, for concatenating the execution parts extracted by the input part and execution part extracting section as a second process, and for arranging the first process to be followed by the second process to generate the macro instruction; and
a macro instruction registering section for registering the generated macro instruction as an instruction executed based on an instruction from a user.

24. The AV device of claim 23, wherein the plurality of unit instructions constituting the macro instruction is automatically selected according to an execution frequency of unit instructions.

25. The AV device of claim 23, wherein the plurality of unit instructions constituting the macro instruction is selected based on an instruction from the user.
